(19) United States
(12) Patent Application Publication
(10) Pub. No.: US 2026/0246912 A1
(43) Pub. Date: Aug. 20, 2026

(54) LIGHT-BASED FIDUCIALS FOR CAMERA CALIBRATION WITH RESPECT TO AN OPTICAL COMPONENT

(71) Applicant: GOOGLE LLC, Mountain View, CA (US)

(72) Inventors: Zhiheng Jia, Sunnyvale, CA (US); Yi Qin, Mountain View, CA (US); Scott Fullam, Palo Alto, CA (US); Chao Guo, Los Altos, CA (US)

(21) Appl. No.: 19/165,481

(22) PCT Filed: Jun. 26, 2024
(86) PCT No.: PCT/US2024/035600

§ 371 Date: Sep. 15, 2025

Related U.S. Application Data
(60) Provisional application No. 63/510,553, filed on Jun. 27, 2023.

(51) Int. Cl. H04N 13/327; H04N 13/383; H04N 13/398

(52) U.S. Cl. CPC H04N 13/327; H04N 13/383; H04N 13/398

(57) ABSTRACT

Light-based fiducials for camera calibration with respect to an optical component are described herein. In one implementation, an imaging system includes an image sensor configured for imaging a subject; an optical component positioned between the image sensor and the subject; a set of fiducials integrated with the optical component in a region associated with a field of view of the image sensor, and a processor. The fiducials may implement discontinuities in a refraction plane of the optical component. The processor may perform a process including receiving an image of the subject from the image sensor; detecting, using the image and based on anomalous light propagation through the respective discontinuities, an arrangement of the set of fiducials; and, based on the arrangement, performing a calibration operation to account for an effect of the optical component on light detected by the image sensor. Corresponding methods, systems, and media are also disclosed.

### RELATED APPLICATIONS

This application claims priority to and the benefit of U.S. Provisional Application No. 63/510,553, filed on Jun. 27, 2023, the disclosure of which is incorporated herein by reference in its entirety.

### BACKGROUND

Cameras capture two-dimensional (2D) representations (e.g., still images, video frames, etc.) of the three-dimensional (3D) world by capturing incoming light from the 3D environment on a light sensitive image sensor after the light passes through a system of optics. Some of these optics (e.g., lenses, waveguides, etc.) may be specifically designed to manipulate the light in a particular way, such as to guide, focus, filter, or otherwise prepare the light to be captured by the image sensor. Other optics, however, such as a cover glass or a protective window may be included for protective or aesthetic reasons, rather than with an objective of manipulating the incoming light in these types of ways.

Regardless of intent or design, incoming light may be at least somewhat influenced by any real-world optics that are traversed on the way to an image sensor, even in cases where it may not be desirable for the light to be manipulated. Accordingly, camera calibration operations may be performed to assess, characterize, correct, and/or compensate for optical effects that may influence images being captured. Such calibration operations may facilitate acquisition of high-quality images and accurate data.

### SUMMARY

Light-based fiducials for camera calibration with respect to an optical component of an imaging system are described herein. For example, calibration operations described herein may be useful for factory and/or online (e.g., in-field) calibration of one or more cameras of a head-mounted extended reality display device with respect to an optical component that may be positioned between an image sensor and a subject being imaged (e.g., a cover glass on the head-mounted device, etc.). Calibrating a camera to account for this type of optical component may be performed by identifying the respective positions of various fiducials associated with the optical component and, based on the identified positions, accounting for (e.g., determining, modeling, correcting, compensating for, etc.) the pose of the optical component. Light-based fiducials described herein provide various benefits by being implemented as small discontinuities in a refraction plane of an optical component such as a cover glass. For example, light allowed or injected into the optical component may emerge from such discontinuities in ways that may be virtually impossible for a human observer to detect or notice and that may even be virtually undetectable in any given image captured by the camera being calibrated. As such, these fiducials can conveniently be placed anywhere on the optical component (including within the field of view of the camera and/or the user) without creating distractions or a loss of perceived quality. When a plurality of image frames captured by the camera are analyzed and filtered to remove dynamic content, light exiting from the small and static discontinuities may be readily identified, such that the discontinuities may serve as robust fiducials to calibrate the camera and account for the influence of the optical component as it changes over time.

To this end, one implementation described herein involves a system (e.g., an imaging system) such as may be included within or associated with a head-mounted display device of an extended reality (e.g., virtual reality, augmented reality, mixed reality, etc.) presentation system. The system may include, for instance, 1) an image sensor configured for imaging a subject; 2) an optical component positioned between the image sensor and the subject; 3) a set of fiducials integrated with the optical component in a region associated with a field of view of the image sensor, the set of fiducials implementing respective discontinuities in a refraction plane of the optical component; and 4) a processor configured to perform a process. The process performed by the processor may include, for instance, receiving an image of the subject from the image sensor; detecting, using the image and based on anomalous light propagation through the respective discontinuities, an arrangement of the set of fiducials; and, based on the arrangement, performing a calibration operation to account for an effect of the optical component on light detected by the image sensor.

Another example implementation described herein involves a method that may be similar to the process described above and may be performed by a similar system (e.g., an imaging system or other computing system). For example, the method may include operations such as: 1) receiving, from an image sensor configured to image a subject through an optical component positioned between the image sensor and the subject, an image of the subject; 2) detecting, using the image and based on anomalous light propagation through respective discontinuities in a refraction plane of the optical component, an arrangement of a set of fiducials, the set of fiducials being integrated with the optical component in a region associated with a field of view of the image sensor and implementing the respective discontinuities; and 3) based on the arrangement, performing a calibration operation to account for an effect of the optical component on light detected by the image sensor.

Yet another example implementation described herein involves a non-transitory computer-readable medium storing instructions that, when executed, cause a processor of an imaging system to perform a process such as the one described above (or similar to the method described above). For example, the process encoded on this non-transitory computer-readable medium may include: 1) receiving, from an image sensor configured to image a subject through an optical component positioned between the image sensor and the subject, an image of the subject; 2) detecting, using the image and based on anomalous light propagation through respective discontinuities in a refraction plane of the optical component, an arrangement of a set of fiducials, the set of fiducials being integrated with the optical component in a region associated with a field of view of the image sensor and implementing the respective discontinuities; and 3) based on the arrangement, performing a calibration operation to account for an effect of the optical component on light detected by the image sensor.

Various additional components and/or operations may be added to these systems and processes as may serve a particular implementation, examples of which will be described in more detail below. Additionally, it will be understood that each of the different types of implementations described in the examples above (i.e., the system, the method, and the non-transitory computer readable medium) may additionally or alternatively be performed by other types of implementations as well. For example, a process described above as being encoded in a computer readable medium could be performed as a method or could be performed by one or more processors of the imaging system. Similarly, the method set forth above could be encoded in instructions stored by a computer-readable medium or stored within the memory of the imaging system, and so forth.

The details of these and other implementations are set forth in the accompanying drawings and the description below. Other features will also be made apparent from the following description, drawings, and claims.

### BRIEF DESCRIPTION OF THE DRAWINGS

FIG. 1 shows certain aspects of an illustrative implementation of light-based fiducials for camera calibration with respect to an optical component in accordance with principles described herein.

FIG. 2 shows a block diagram of an illustrative imaging system that may use light-based fiducials for camera calibration with respect to an optical component in accordance with principles described herein.

FIG. 3 shows an illustrative method for using light-based fiducials for camera calibration with respect to an optical component in accordance with principles described herein.

FIG. 4 shows an illustrative imaging system with various image sensors and optical components that may benefit from camera calibration using light-based fiducials in accordance with principles described herein.

FIG. 5 shows certain aspects of an illustrative optical component that includes light-based fiducials that may be used for camera calibration in accordance with principles described herein.

FIG. 6 shows illustrative ways that light may be introduced into an illustrative optical component for use in illuminating light-based fiducials for camera calibration in accordance with principles described herein.

FIG. 7 shows illustrative ways that light-based fiducials may be arranged with respect to the different fields of view in accordance with principles described herein.

FIG. 8 shows illustrative aspects for how a plurality of images may be processed to detect an arrangement of light-based fiducials that may be virtually undetectable from any individual image in accordance with principles described herein.

FIGS. 9A and 9B show different illustrative timelines for calibration sequences employing light-based fiducials illuminated by injected light in accordance with principles described herein.

FIG. 10 shows an illustrative computing system that may be used to implement various devices and/or systems described herein.

### DETAILED DESCRIPTION

Various types of imaging systems include one or more cameras configured to capture images that are then used by the systems for various purposes. For example, imaging systems such as standalone camera devices, mobile devices (e.g., smartphones, tablets, laptop computers, etc.), automotive imaging systems, and various other types of systems all employ imaging technology to capture and analyze the environment and make use of this information for various purposes (e.g., to store photo or video memories, to facilitate vehicle navigation, etc.). While principles described herein may apply to any of these or various other imaging systems, a particular type of imaging system will be referred to in the following disclosure to help provide concrete description, illustrations, and examples as these principles are set forth. This particular type of imaging system is a head-mounted display device associated with an extended reality presentation system such as a virtual reality, augmented reality, mixed reality, and/or other type of extended reality system configured to present extended reality content to a wearer of the head-mounted display device.

As with various other imaging systems, a head-mounted display device may include a variety of different cameras configured to capture different subjects for different purposes. For instance, a modern head-mounted display device may include several world-facing cameras configured to scan the environment (e.g., to capture imagery from which a working model of the environment may be constructed), as well as to monitor input to the system that may depend on the respective poses of controller devices held by a user. In some examples, system control may be done partly or entirely by the hands of a user (e.g., in the form of pointing, gestures, etc.), such that one or more cameras may be specifically dedicated (e.g., based on the orientation of the cameras, the processing of the images they capture, etc.) to monitoring the hands of the person wearing the head-mounted display device. Along with these various world-facing cameras, a head-mounted display device may also implement one or more inward-facing cameras that could be used during an extended reality experience to track the user's eyes, capture the user's facial expressions, and so forth.

Each of these example cameras may include certain components such as optical components and one or more image sensors. The optical components, for instance, may be configured to focus and prepare incoming light from a subject (e.g., from the scene or environment in which the experience is taking place, from the user's hands, from the user's eyes or face, from one or more objects in the field of view, etc.) to be captured by the image sensor, which may be implemented as a light-sensitive chip that converts the prepared light into digital image data that can be processed, used, presented, and so forth in the course of system operation. As mentioned above, certain optical components such as lenses and waveguides may be specifically configured to manipulate and prepare the light in specific ways (e.g., by guiding, focusing, filtering, and/or otherwise preparing the light to be captured by the image sensor), while other optical components such as a cover glass or a protective window may be included for protective or aesthetic reasons and would ideally not manipulate or influence the light at all (though this ideal cannot be achieved with real-world optical components, which will always have at least some effect on the light).

Camera calibration with respect to each optical component or system of components (e.g., an optical stack) may be useful or necessary to ensure that the imaging system acquires high-quality images and interprets the image data in accurate and effective ways. Various calibration techniques to this end may be used both in an initial calibration (e.g., a factory calibration) of the cameras and for later updates to the calibration (e.g., an online or in-field calibration update). For instance, lenses and other optical components specifically designed to manipulate light in certain ways may be characterized to determine unique calibration parameters such as focal length, distortion parameters, and/or other performance metrics for the components.

It may also be important to characterize and account for more passive optical components (e.g., those that are included for aesthetic, protective, or other reasons, such as a cover glass of the head-mounted display device) in the camera calibration. Certain technical problems may be associated with this part of the camera calibration, however. To illustrate one such technical problem, a cover glass of a head-mounted display device (e.g., a single-piece, curved, transparent cover window, formed from any suitable glass or plastic material, that stretches across the entire front of the device) will be considered. While the objective of the cover glass in the head-mounted display device system may be largely aesthetic and/or protective, as opposed to optical, the curved material may nevertheless influence (e.g., distort, shift, partially reflect, etc.) incoming light from the environment prior to the light reaching other optical elements and/or the image sensors of the various world-facing cameras that a head-mounted display device may include.

Accordingly, it may be desirable to model and account for this influence on the light. At least one challenge that arises in this analysis, however, is that various conditions and events may cause the cover glass and the effects it exerts on the incoming light to change. For instance, temperature changes may cause the cover glass and/or adhesives holding it in place to expand and/or contract in ways that affect the position or pose (e.g., tilt, curvature, etc.) of the glass and therefore affect the influence of the cover glass on the incoming light.

As another example, vibration and/or discrete mechanical events (e.g., the head-mounted display device being accidentally dropped, etc.) may cause the cover glass to move and shift in ways that similarly need to be accounted for. Because the cover glass may be largely transparent and otherwise designed to minimally affect the light, as well as because the cover glass may be attached to a frame that is somewhat independent from the rest of the optics influencing the light, optical effects that the cover glass exert may tend to be subtle and difficult to model using conventional calibration techniques involving external calibration objects (e.g., checkerboards, grids of known patterns of circles or other shapes, etc.).

Implementations described herein provide a technical solution to these technical problems by providing fiducials right on the optical element (e.g., the cover glass) itself so that optical effects of the cover glass may be detected, tracked, and properly accounted for even as the pose of the cover glass changes over time. For example, a mathematical model for the cover glass may be designed or initially determined (e.g., as part of factory calibration, where a high degree of visibility may be available) and then updates to this model may be implemented in the field based on how the fiducials indicate that the pose of the cover glass has changed.

While it might be somewhat straightforward to conspicuously mark an optical component (such as the cover glass) with readily identifiable fiducials, another technical problem arises with this type of approach. If the fiducials applied to the optical component are large enough to be visible and easily identified in a given image captured by a given camera behind the optical component, the fiducials are likely also large enough to create a permanent blind spot within the camera's field of view. Such a blind spot may be distracting and/or annoying to a user, at best, and may significantly compromise the system functionality or ruin the visual experience for the user in more extreme cases.

This technical problem, too, may be addressed by implementations described herein. For example, a technical solution to this problem may be implemented by using what are referred to herein as light-based fiducials. As will be described and illustrated in more detail below, very small discontinuities (e.g., small enough to be undetectable or unnoticeable to the naked eye and to be undetectable in any given image captured by the camera) may be introduced within a refraction plane of the optical component. For example, small bits of material may be added to or removed from the material of the optical component to change the light refraction interface at these points. In this way, light that is introduced into (e.g., injected and/or allowed into) the optical component may reflect back and forth between the surfaces of the optical component until it emerges from these discontinuities in ways that are anomalous as compared, for example, with other light from the subject that passes straight through the cover glass. For example, anomalous light may propagate through the fiducials at different angles than other light passing through the cover glass, may have different color or intensity attributes, or may otherwise be distinguishable as anomalous due to a change in refractive index associated with the light-based fiducials. By analogy, a fingerprint or scratch on an otherwise clean and flawless window may be virtually invisible under most conditions but may be visible when light interfaces with the fingerprint or scratch in a particular manner. The discontinuities introduced to implement light-based fiducials may function using a similar principle but may be even smaller than a defect or smudge such as the fingerprint or the scratch mentioned above.

While light-based fiducials implementing the discontinuities in the refraction plane of the optical component may not be visible within an individual image or by an observer looking at what appears to be a perfectly smooth and flawless cover glass, the fiducials may nevertheless be detectable using principles described herein. For example, since light being injected into the optical component may help emphasize the discontinuity, a light source under control of the system may be used to inject light only when it is desirable for the fiducials to be used (e.g., during a calibration sequence). As another example, the fiducials may be detected not based on any individual image but, rather, by a large number of images that are processed so as to filter out the dynamic content (e.g., the subject external to the cover glass) and to make apparent the static content (e.g., the light-based fiducials, which may remain virtually static with respect to the field of view throughout dozens or hundreds of frames, even as the rest of the content shifts and moves). In these and other ways, light-based fiducials described herein provide a technical solution to the technical problem of camera calibration requiring fiducials integrated with the optical components that are also inconspicuous and do not take away substantively from the images being captured.

Technical effects of these solutions to the technical problems that have been enumerated include robust and highly-effective fiducials that can be used for effective camera calibration with respect to optical components that might otherwise be difficult to account for in an inconspicuous way. Because of the novel light-based approach that fiducials described herein may employ (whether actively or passively illuminated), the fiducials may be included in a region of the optical component that is associated with the field of view of the camera and the user without causing functional or experiential issues during a given operation session (e.g., while a user uses a head-mounted display device to engage in an extended reality experience). At the same time, the fiducials may be readily detected using techniques described herein such that optical components such as cover glasses may be consistently accounted for in their influence on imagery captured by the cameras behind the components. Ultimately, camera calibration operations may be performed to assess, characterize, correct, and/or compensate for optical effects on images being captured to thereby facilitate acquisition of high-quality images and accurate data. At the same time, the fiducials used for this camera calibration may avoid distracting the user and/or compromising system operations in any way.

Various implementations will now be described in more detail with reference to the figures. It will be understood that particular implementations described below are provided as non-limiting examples and may be applied in various situations. Additionally, it will be understood that other implementations not explicitly described herein may also fall within the scope of the claims set forth below. Systems and methods described herein for light-based fiducials for camera calibration with respect to an optical component may result in any or all of the technical effects mentioned above, as well as various additional effects and benefits that will be described and/or made apparent below.

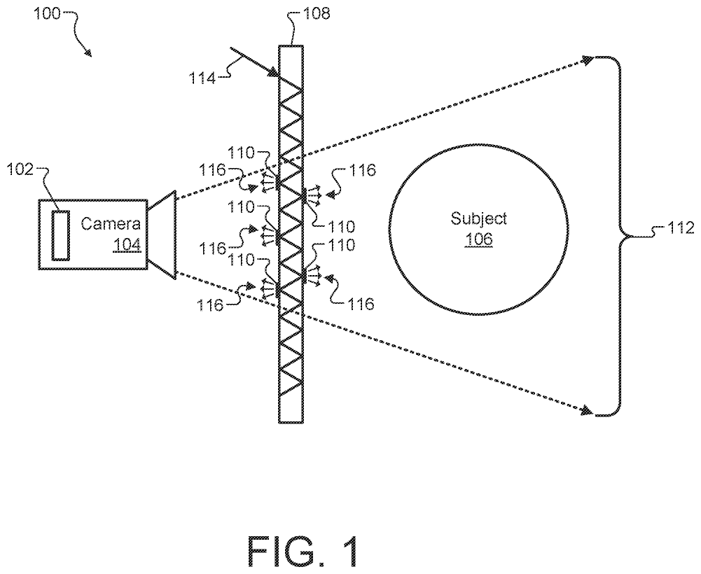

FIG. 1 shows certain aspects of an illustrative implementation 100 of light-based fiducials for camera calibration with respect to an optical component in accordance with principles described herein. It will be understood that while the implementation 100 illustrated in FIG. 1 shows certain features and attributes that may be present in certain examples, other features and attributes not included as part of this implementation and/or not explicitly illustrated in FIG. 1 may also be present in other implementations (as will be described below in reference to various additional example implementations).

As shown, implementation 100 illustrates elements of an example imaging system including an image sensor 102 that is included within a camera 104 and configured for imaging a subject 106. The imaging system is also shown to include an optical component 108 positioned between image sensor 102 and subject 106, such that light from subject 106 may propagate to image sensor 102 by way of (i.e., through or via) optical component 108. Also shown in implementation 100 is a set of fiducials 110 that are integrated with optical component 108 in a region of optical component 108 that is associated with a field of view 112 of image sensor 102 (i.e., a field of view of camera 104). Light 114 that is injected or allowed to reflect back and forth between surfaces of optical component 108 is shown to emerge as light 116 from fiducials 110. More particularly, the set of fiducials 110 may implement respective discontinuities in a refraction plane of the optical component, such that light 116 anomalously propagates through each of the respective discontinuities to reveal, when detected in accordance with techniques described herein, an arrangement of the set of fiducials 110 as changes occur to optical component 108. Each of the elements of implementation 100 will now be described in more detail.

Image sensor 102 may be implemented as any suitable image sensing device as may serve a particular implementation. For example, image sensor 102 may represent an image sensor chip implemented using a technology such as complementary metal-oxide-semiconductor (e.g., a CMOS image sensor). While this type of image sensor may be configured to capture conventional images (e.g., photos, videos, etc.), other image sensor examples may capture other types of images for other purposes. For instance, image sensor 102 could represent a depth sensor that operates using light detection and ranging (LiDAR) or other similar time-of-flight (ToF) principles.

Camera 104 may represent not only the image sensor 102 described above, but also additional optical, hardware, and/or software elements that may interoperate with image sensor 102 to generate the images produced by the camera. For example, along with image sensor 102, camera 104 may include various optics (e.g., lenses, waveguides, etc.) independent from optical component 108, as well as other optical or computing resources configured to generate usable images based on light detected by image sensor 102. While an individual camera 104 with an individual image sensor 102 is illustrated in this implementation, it will be understood that certain imaging systems (e.g., including a head-mounted display device such as in the examples described above) may include several independent or interdependent (e.g., resource sharing) cameras and image sensors. For example, a head-mounted display may include a plurality of cameras, some of which may face in different directions (e.g., out toward the environment, down toward a user's hands, back towards a user's eyes and face, etc.) and some of which may face in generally the same direction (e.g., to be used stereoscopically for depth detection or other such purposes).

Subject 106 may represent whatever physical subject the camera 104 is oriented toward and configured to capture images of at a particular moment. For instance, subject 106 (illustrated, generically, as a circle in FIG. 1) could represent a scene or environment, an object or plurality of objects within a scene, a person (e.g., a user of the imaging device, a person whose picture is being taken, etc.) or a particular feature of the person (e.g., the person's hands, eyes, face, etc.), or any other subject as may serve a particular implementation. As mentioned above, for imaging systems like head-mounted display devices that include a plurality of cameras, the cameras may be oriented such that each camera captures images of a different subject. For instance, one camera could capture a subject including the environment in which the user is located and various objects included therein; another camera could capture a subject including the user's hands as they perform gestures or hold controllers that control the extended reality experience; yet another camera could capture a subject including the user's eyes as they look at different parts of the extended reality presentation being presented; and so forth.

Optical component 108 may represent any optical element or system through which light may pass on the way from subject 106 toward camera 104 and image sensor 102. For example, as described above, one type of optical component 108 that may be convenient for illustrating various principles described herein (though it is not the only optical component to which these principles apply) is a cover glass for a head-mounted display device. Such a cover glass may be constructed from glass, plastic (e.g., acrylic), or another suitable material and may be mounted to a frame of the head-mounted display device in a manner somewhat independent from the mounting of elements of camera 104 within the head-mounted display device. As such, changes to optical component 108 may tend to occur independently from changes to the elements of camera 104 (thus possibly creating a benefit when the optical component is characterized and modeled separately from these elements).

As illustrated in implementation 100, this type of optical component 108 may be implemented as a flat plate or sheet that provides a narrow channel between two substantially parallel surfaces (as opposed to a prism, which may provide much thicker area between the surfaces, and as opposed to a lens, which may have surfaces that are intentionally concave or convex to manipulate light in a particular way). As shown, some light 114 that enters optical component 108 at a certain angle may be become effectively trapped inside the optical component 108, reflecting back and forth between the parallel surfaces due to total internal reflection principles and as illustrated by the zigzag pattern extending from light 114. This internal reflection that occurs for light 114 after entering the optical component 108 stands in contrast to other light (e.g., light reflecting from subject 106), which may pass straight through the optical component at other angles.

The set of fiducials 110 may implement respective discontinuities in a refraction plane of optical component 108 where the light trapped within the optical component may more easily emerge or exit from the component (e.g., as light 116). In implementation 100, the set of fiducials 110 is shown to include fiducials 110 on both surfaces of optical component 108 (i.e., the surface facing the camera and the surface facing subject 106) and each of the fiducials 110 is shown to be included in a region associated with field of view 112 of camera 104. In this way, small segments of light 116 may emerge at these fiducials 110 on each side of optical component 108 when light 114 is being supplied, and the bits of light on the camera side may be detectable within the field of view 112.

As mentioned above and as will be described in more detail below, fiducials such as the set of fiducials 110 may be too small to be readily detectable based on a single image and/or when not being illuminated by light 114 (e.g., either by active illumination from a light source controlled by the imaging system or passive illumination from ambient light that is allowed to enter at the proper angle). For example, the fiducials may be comparable in size (and as readily detectable from a single image) as a small speck of dust that has landed on the optical component 108. As will be described, certain techniques involving illuminating the fiducials and possibly processing and analyzing large groups of images may help the arrangement of the set of fiducials 110 to be detected. It will be understood that, in other implementations, all the fiducials could be limited to one surface or the other, and there could be fiducials that are located outside of the field of view 112.

As mentioned above and as will be further detailed below, an optical component such as optical component 108 may, over time, change the ways it influences and affects light passing through (e.g., from subject 106 to be captured by image sensor 102 of camera 104). For instance, as mentioned, temperature changes, discrepancies in how the optical component 108 is manufactured and/or attached to the frame (e.g., by way of adhesive), mechanical events such as the system being dropped, and so forth may cause optical component 108 to bend, flex, shift, expand, contract, or otherwise change in various ways. The set of fiducials 110 may be useful in identifying exactly how optical component 108 may have changed so that extrinsic parameters of optical component 108 with respect to camera 104 may be originally identified and then tracked and kept up to date. The process of assessing the optical component 108 and modeling (or updating a model for) how optical component 108 affects light detected by image sensor 102 is referred to herein as camera calibration, and, in particular, camera calibration with respect to the optical component. By performing one or more calibration operations based on a detected arrangement of the set of fiducials 110 as changes occur to optical component 108, the system may properly account for an effect of optical component 108 on the light being detected by the image sensor. For example, as optical component 108 is shifted or warped (i.e., flexed, etc.), different transforms may be applied to data captured by image sensor 102 to correct or compensate for the effects that the shifting and/or warping may have had on the light. In this way, errors may be corrected or avoided and high-quality imaging may be ensured.

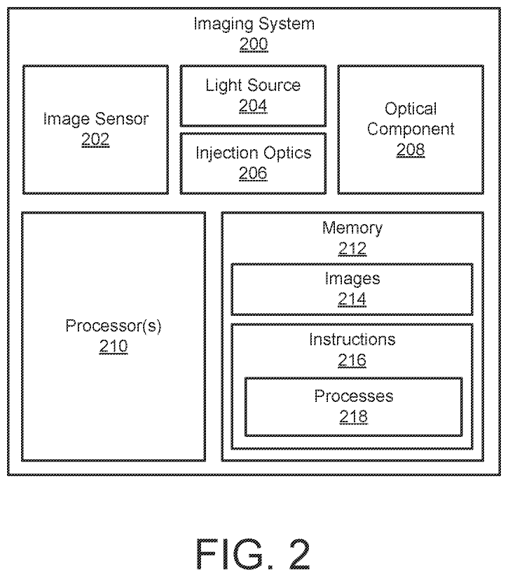

FIG. 2 shows a block diagram of an illustrative imaging system 200 that may use light-based fiducials for camera calibration with respect to an optical component in accordance with principles described herein. As has been described, many examples provided herein assume a head-mounted display device implementation of imaging system 200. It will be understood, however, that imaging system 200 may be implemented as any of a variety of imaging systems other than the head-mounted display devices described and illustrated herein. For example, a camera included in a vehicle navigation assistance system (e.g., for fully automated driving, adaptive cruise control, assisted parking, etc.) may be protected by a cover window with certain similar characteristics as those described herein for head-mounted display devices. Camera calibration for these systems may therefore benefit from the same types of principles described herein for head-mounted display devices. Similarly, cameras included in standalone still or video camera devices, mobile devices such as phones or tablets, and so forth, may also similarly benefit from the same principles. As such, imaging system 200 will be understood to represent any of these or other suitable imaging systems as may serve a particular implementation.

As shown, imaging system 200 may include an image sensor 202, a light source 204, an injection optics 206, an optical component 208, one or more processors 210, a memory 212 that stores images 214 and instructions 216 for one or more processes 218, and possibly various other components not explicitly shown in FIG. 2. The components in FIG. 2 may be selectively coupled to one another in any manner as may serve to facilitate functions described herein. For instance, the processors 210 may be communicatively coupled to memory 212 to load instructions 216 as processes 218 are executed. Similarly, image sensor 202 may be communicatively coupled to processors 210 to provide images captured by image sensor 202 for processing by processors 210 and storage within memory 212 as images 214. Light source 204 and injection optics 206 may be similarly coupled with one another and with optical component 208 to properly serve the function, described and illustrated in more detail below, of injecting light from light source 204 into optical component 208 at an optimal angle for illuminating a set of set of fiducials (e.g., the set of fiducials 110, not explicitly shown in FIG. 2). Each of these components will now be described in more detail.

Image sensor 202 may implement an image sensor similar to image sensor 102, described above in relation to implementation 100. As such, image sensor 202 may be implemented by any of the types of images sensors described in relation to image sensor 102. As was shown and described above, image sensor 202 may be configured for imaging any suitable subject as a camera may be oriented toward (i.e., a camera in which image sensor 202 is included, not explicitly represented in FIG. 2).

Light source 204 may be implemented as any suitable light source that can be controlled by imaging system 200 (e.g., turned off and on in accordance with instructions 216 of various one or more processes 218, etc.) and that can be used (in association with injection optics 206) to inject light into optical component 208 at a particular angle that will allow the light to be substantially trapped or captured within the component. In some examples, light source 204 may be implemented by a laser or other source of collimated light.

Injection optics 206 may be configured (e.g., shaped, positioned, posed, angled, etc.) to facilitate injection of light from light source 204 (e.g., analogous to light 114 illustrated in FIG. 1) into optical component 208. As such, injection optics 206 may include a waveguide, a prism, a mirror or other reflective surface, and/or any other suitable optical device configured to inject light from light source 204 into optical component 208 at a desired angle.

Optical component 208 may implement an optical component similar to optical component 108, described above in relation to implementation 100. As such, optical component 208 may be implemented by any of the types of optical components described in relation to optical component 108 or described elsewhere herein. For example, optical component 208 may be implemented as a curved cover glass covering a front surface of a head-mounted display device. However it may be implemented, optical component 208 may be positioned between image sensor 202 and a subject that is being captured (not shown in FIG. 2 since the subject is generally not part of the imaging system 200). While not shown explicitly in FIG. 2, it will be understood (as illustrated in FIG. 1 and in other figures described below) that optical component 208 may include a set of fiducials (e.g., fiducials 110) that are integrated with optical component 208 in a region associated with a field of view of image sensor 202. This set of fiducials may implement respective discontinuities in a refraction plane of optical component 208, as will be further illustrated and described below.

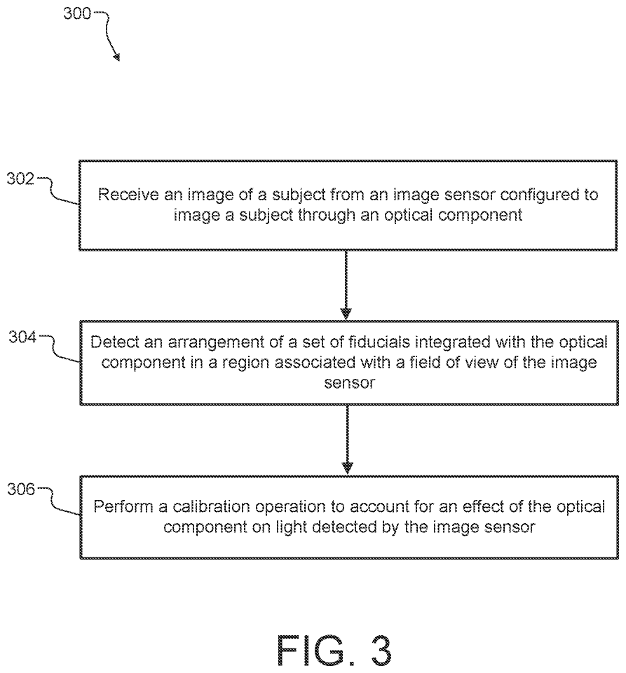

Processors 210 may represent one or more general purpose processors (e.g., central processing units (CPUs), microprocessors, etc.), one or more special purpose processors (e.g., graphics processing units (GPUs), field programmable gate arrays (FPGAs), application specific integrated circuits (ASICs), etc.), and/or any other processors as may serve a particular implementation. As mentioned above, processors 210 may be communicatively coupled to memory 212 to store data in memory 212 and/or to load data from memory 212. For instance, processors 210 may be used to perform one or more processes 218 by loading, from memory 212, instructions 216 that encode the process. Image data and other data (including images 214) may be loaded or stored as part of executing these processes, as will be made apparent in the following description of FIG. 3.

FIG. 3 shows an illustrative method 300 for using light-based fiducials for camera calibration with respect to an optical component in accordance with principles described herein. Method 300 may be implemented within one of processes 218 so that it may be executed by imaging system 200. Method 300 shows one sequence of operations that may be performed by an imaging system such as imaging system 200, it will be understood that other implementations of method 300 could omit, add to, reorder, and/or modify any of operations 302-306 shown in FIG. 3. While operations shown in FIG. 3 are illustrated with arrows suggestive of a sequential order of operation, it will be understood that some or all of the operations of method 300 may be performed concurrently (e.g., in parallel) with one another. Each of operations 302-306 of method 300 will now be described in more detail as the operations may be performed by an imaging system (e.g., imaging system 200) that includes at least an image sensor (e.g., image sensor 202), an optical component (e.g., optical component 208), and a processor (e.g., processors 210) configured to perform operations 302-306. Each of these operations will now be described in more detail.

At operation 302, the imaging system may receive an image of a subject. For example, the image may be received from an image sensor of the imaging system (e.g., image sensor 202) that is configured to image a subject (e.g., subject 106) through an optical component (e.g., optical component 208) positioned between the image sensor and the subject. The image sensor may image the subject upon a command received by a user, or a processor.

At operation 304, the imaging system may use this image to detect an arrangement of a set of fiducials. For example, the imaging system may detect, using the image and based on anomalous light propagation through the respective discontinuities, the arrangement of the set of fiducials. In some examples, the singular image captured at operation 302 may not readily show the arrangement of the set of fiducials in a way that is straightforward to detect. However, as will be described and illustrated in more detail below, the individual image received at operation 302 may, when processed and filtered together with several other images (e.g., dozens or hundreds of other images in some examples), be useful in revealing the arrangement of the set of fiducials. The detecting at operation 304 may be performed based on anomalous light propagation through respective discontinuities in a refraction plane of the optical component. For example, as has been described and as will be illustrated and detailed below, the set of fiducials may be integrated with the optical component in a region associated with a field of view of the image sensor and may implement the respective discontinuities. As such, when light emerging from these fiducials in an anomalous way (e.g., at different angles or with different attributes, due to refractive index changes caused by the discontinuities implemented by the fiducials) is assessed over the course of many image frames, the arrangement of fiducials may be detectable despite being effectively invisible for any individual frame. Since these discontinuities cause small amounts of light (e.g., light 116) to be emitted that would otherwise be substantially trapped within the optical component, the fiducials implementing these discontinuities are referred to herein as light-based fiducials.

At operation 306, the imaging system may perform a calibration operation based on the arrangement of the set of fiducials detected at operation 304. Based on this calibration operation (and possibly based on other operations in a calibration sequence of such operations), the imaging system may account for an effect of the optical component on light detected by the image sensor. For example, the arrangement of the set of fiducials may indicate, based on analysis associated with the calibration operation, that the optical component has shifted, flexed, warped, or otherwise changed in a way that is to be accounted for in the modeling of how the optical component affects light detected by the image sensor.

Method 300 may be performed by any imaging system described herein, including implementations of imaging system 200 described and illustrated above. In some examples, such imaging systems may include, along with image sensors and optical components, one or more processors configured to perform a process implementing method 300 (i.e., a process including operations 302-306 and additional or alternative operations in certain examples). Another way that method 300 may be implemented is embodied as instructions on a non-transitory computer-readable medium. For example, the non-transitory computer-readable medium storing instructions that, when executed, cause a processor of an imaging system to perform a process implementing method 300.

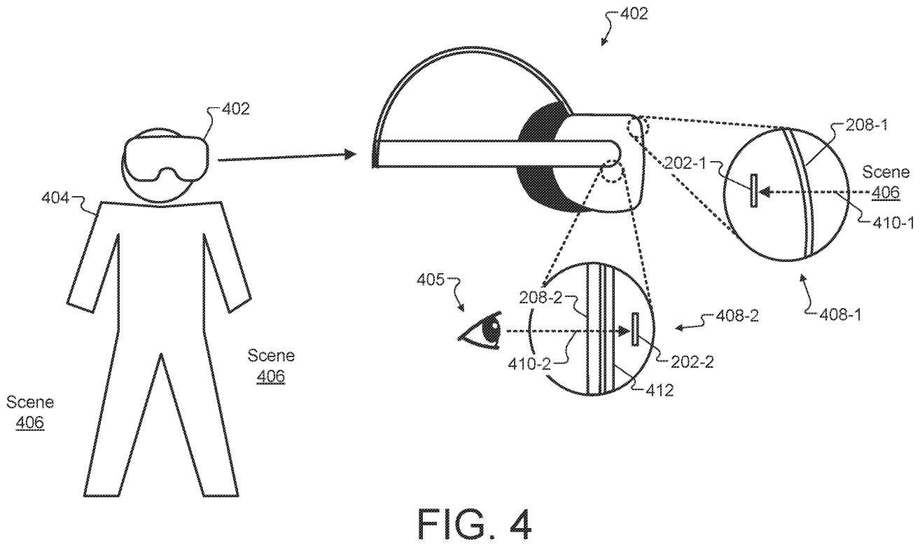

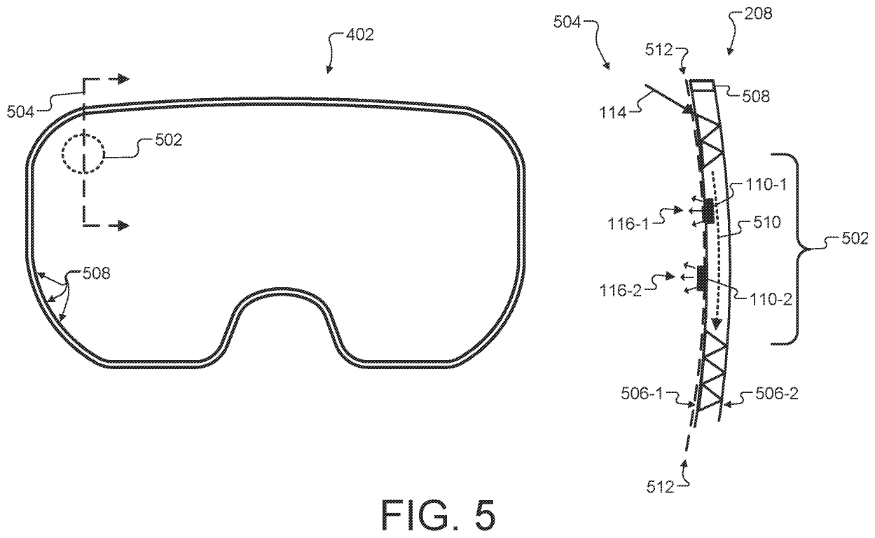

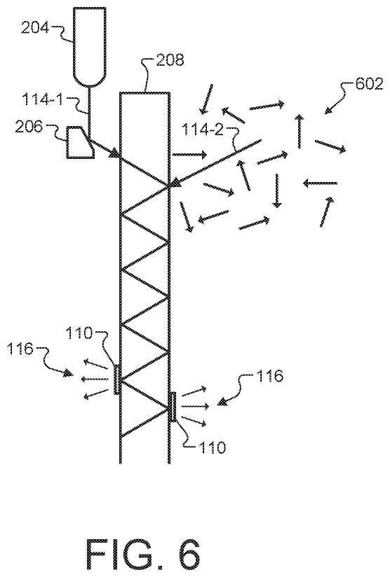

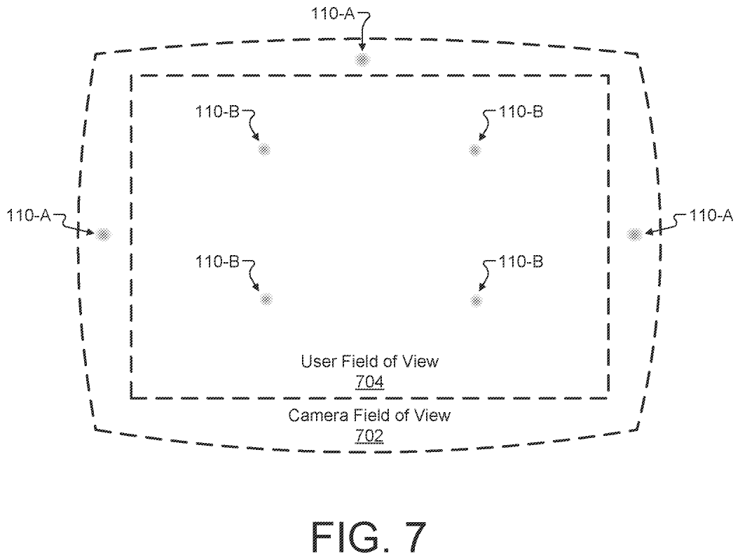

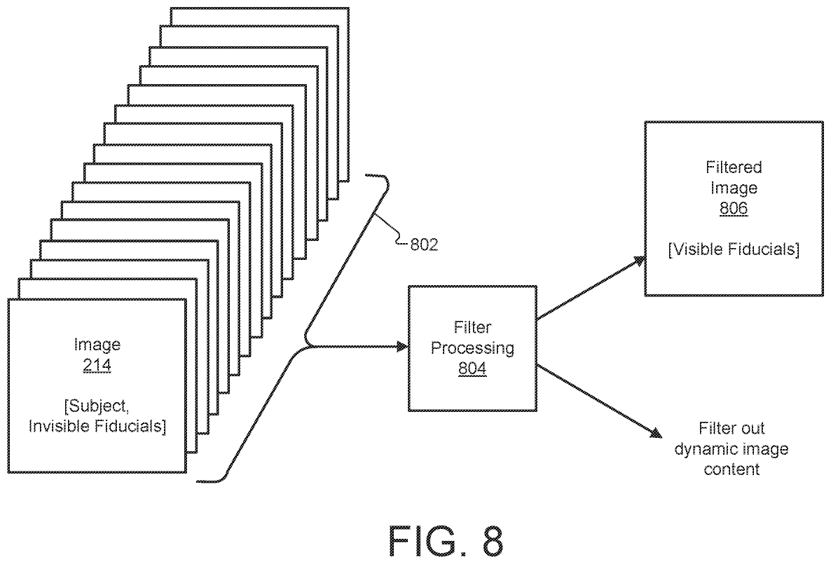

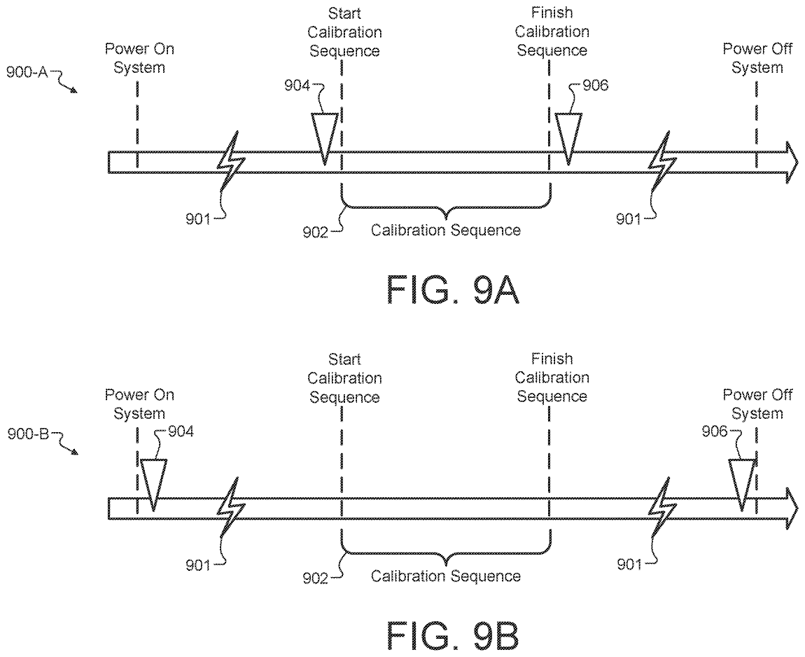

Implementation 100 illustrated a broad example of how camera calibration may be performed with respect to certain optical components using light-based fiducials such as described herein. A broad example of an imaging system 200 that is configured to make use of such light-based fiducials was described in relation to FIG. 2 and a broad example of a method for using such light-based fiducials in furtherance of the camera calibration was described in relation to FIG. 3. FIGS. 4-8 and 9A-9B will now be described to further detail various aspects of the broad implementations already described, as well as to provide additional context and more specific detail about how various implementations may be configured or performed. More particularly, FIG. 4 illustrates aspects of a specific example of an imaging system (implemented as a head-mounted display device), FIG. 5 illustrates different ways of implementing the light-based fiducials on a particular type of optical component, FIG. 6 illustrates different ways that light may be introduced into an optical component to actively or passively illuminate light-based fiducials, FIG. 7 illustrates certain aspects of fiducial placement with respect to different fields of view, FIG. 8 illustrates how a large number of images may be processed and filtered to detect light-based fiducials that would be virtually invisible on any individual image, and FIGS. 9A and 9B illustrate examples of when calibration sequences may be performed and when active illumination may be applied.

In FIG. 4, an illustrative imaging system (e.g., an implementation of imaging system 200) is shown to be implemented more specifically as an extended reality presentation system that includes a head-mounted display device 402 in which image sensors and optical components are integrated. As shown from a front view on the left-hand side of FIG. 2, head-mounted display device 402 may be worn by a user 404 at a scene 406. As then shown from a side view on the right-hand side of FIG. 2, head-mounted display device 402 may include a variety of image sensors 202. For example, a first expanded cross section 408-1 of head-mounted display device 402 shows a first image sensor 202-1 that captures light 410-1 from scene 406 as the light passes through a first optical component 208-1. The components shown in expanded cross section 408-1 will be understood to represent illustrative implementations of the similarly-labeled elements described above (i.e., image sensor 202 and optical component 208). More particularly, in this case, optical component 208-1 may be implemented by a cover glass for head-mounted display device 402 and image sensor 202-1 may be implemented by a world-facing camera behind the cover glass in the head-mounted display device. By using light-based fiducials to perform camera calibration with respect to optical component 208-1, head-mounted display device 402 may properly account for an effect of the cover glass on light 410-1 detected by image sensor 202-1.

A second expanded cross section 408-2 of head-mounted display device 402 then shows a second image sensor 202-2 that captures light 410-2 from an eye 405 of user 404 (e.g., as part of an eye-tracking camera) as the light passes through a second optical component 208-2. Again, the components shown in expanded cross section 408-2 will be understood to represent illustrative implementations of the similarly-labeled elements described above (i.e., image sensor 202 and optical component 208). More particularly, in this case, optical component 208-2 may be associated with an internal display 412 (e.g., a display screen) for head-mounted display device 402 and image sensor 202-2 may be associated with an eye-tracking camera integrated within head-mounted display device 402 to track eye movements of user 404 as eye 405 views internal display 412. For example, a waveguide may carry light from a display panel to the internal display, which may also allow light 410-2 to pass through to image sensor 202-2 behind the internal display 412, as shown. In other examples, the eye-tracking camera may be placed elsewhere (i.e., to the side or above or below internal display 412). In any case, by using light-based fiducials to perform camera calibration with respect to optical component 208-2, head-mounted display device 402 may properly account for an effect of the internal display optics on light 410-2 detected by image sensor 202-2.

While two expanded cross sections 408-1 and 408-2 are shown specifically in FIG. 4 to illustrate a world-facing camera setup and a user-facing camera setup, it will be understood that various other cameras may also be included within head-mounted display device 402 and similar principles may be applied to likewise account for effects of any optical components that may be positioned between the respective image sensors and the subjects that they are configured to image.

FIG. 5 shows certain aspects of an illustrative optical component that includes light-based fiducials that may be used for camera calibration in accordance with principles described herein. More particularly, FIG. 5 shows a straight-on view of head-mounted display device 402 and indicates, with a dotted circle, a field of view 502 of a world facing camera integrated with head-mounted display device 402 (e.g., the camera associated with image sensor 202-1 and expanded cross section 408-1 described in FIG. 4). While field of view 502 is relatively small on the cover glass (e.g., optical component 208) since it is so close to the integrated camera, it will be understood that the field of view grows larger as it emerges from head-mounted display device 402 to capture a substantial portion of the environment in which head-mounted display device 402 is located (e.g., similar to field of view 112 shown in FIG. 1).

A cross section 504 of a portion of optical component 208 (i.e., the cover glass of head-mounted display device 402) is indicated in the straight-on view and is shown in more detail on the right-hand side of FIG. 5. Specifically, a portion of optical component 208 is shown to be curved (e.g., a spherical or other suitable curve to create a streamlined contour for head-mounted display device 402) and to feature a set of fiducials including a fiducial 110-1 and a fiducial 110-2 positioned within a region of optical component 208 associated with field of view 502. As such, fiducials 110-1 and 110-2 will be understood to be included in images captured by the camera associated with field of view 502, though, as has been described, the fiducials will be understood to be small enough that they may be practically invisible or undetectable in any individual image (neither field of view 502 nor fiducials 110-1 and 110-2 are necessarily drawn to scale). Cross section 504 further shows other aspects described herein, such as anomalous light 116-1 and 116-2 that respectively emerges from fiducials 110-1 and 110-2 when light 114 is introduced into optical component 208.

The cover glass implementation of optical component 208 in FIG. 5 is shown to be implemented as a planar component having a first planar surface 506-1 (i.e., an inner surface facing the camera and the internal circuitry of head-mounted display device 402), a second planar surface 506-2 opposite and parallel to first planar surface 506-1 (i.e., an outer surface facing the environment), and a perimeter edge 508 connecting the two planar surfaces 506-1 and 506-2. Perimeter edge 508 is shown within cross section 504 at the top of optical component 208 where the edge of the component will be understood to meet a frame of head-mounted display device 402 (the bottom of optical component 208 is not shown in cross section 504 as it is shown to cut off midway through the cover glass). The straight-on view of head-mounted display device 402 also labels perimeter edge 508 in a few points to indicate that perimeter edge 508 may refer to an entire edge of the cover glass going all the way around.

At least a portion of perimeter edge 508 may be configured to reflect light propagating between first planar surface 506-1 and second planar surface 506-2 to deter the light from exiting optical component 208 at perimeter edge 508. For instance, light 114 that is injected or allowed to enter and propagate between the planar surfaces is shown to have the same type of zigzag described above (though, for clarity of illustration, part of the zigzag pattern is omitted and replaced with an arrow 510 that will be understood to represent a continuation of the same light reflection pattern). Light 114 may propagate in this manner, trapped between planar surfaces 506-1 and 506-2, until reaching a fiducial or the perimeter edge 508, where the light may escape. By configuring perimeter edge 508 to reflect the light, however, this may facilitate keeping as much light as possible trapped within optical component 208 so that more light will exit as light 116-1 and 116-2 at fiducials 110-1 and 110-2. The reflective surface at perimeter edge 508 may be implemented by applying a reflective paint or other suitable material around at least a portion of the perimeter of the glass.

While only two fiducials 110-1 and 110-2 are explicitly shown in FIG. 5, it will be understood that any suitable number of fiducials in a set of fiducials included on optical component 208 and associated with a particular camera such as the camera of field of view 502 may be used. For instance, in certain examples, an arrangement of at least three non-linear fiducials may be used to determine the orientation of optical component 208 (since three points on a surface geometrically define the plane of that surface). In this example, it may be that fiducials 110-1 and 110-2 happen to be collinear along cross section 504, while at least one additional fiducial (not shown in FIG. 5) that is non-collinear with fiducials 110-1 and 110-2 is also located within the region associated with field of view 502.

As used herein, a fiducial may refer to any well-defined and recognizable object placed within a camera field of view that may be used as a reference point for camera calibration. As further used herein, light-based fiducials refer more specifically to fiducials, such as fiducials 110-1 and fiducials 110-2, that implement a discontinuity in a refraction plane of an optical component, such that light propagates anomalously through the discontinuity so as to be detectable. Such discontinuities may be implemented in various ways, but may each produce anomalous light in the sense that the discontinuities change the interface or behavior of light at the discontinuous points as compared to surrounding points on the refraction plane. This change in the behavior leads to anomalous light such as light 116-1 and 116-2 that emerges from the fiducials and may be detected in ways described herein.

For illustrative purposes, FIG. 5 shows two different ways that a discontinuity in a refraction plane of an optical component may be made (though it will be understood that a set of fiducials in any given implementation may be implemented in the same way rather than in different ways as shown in this example). In this example, both fiducials are on the inside surface of the cover glass (i.e., first planar surface 506-1), so a refraction plane 512 coincident with planar surface 506-1 is illustrated as a dotted line along the surface. As shown in other examples herein, it will be understood that other fiducials could be placed on the outer surface of the cover glass, such that they would implement discontinuities on a refraction plane coincident with second planar surface 506-2 (not shown in FIG. 5).

Fiducial 110-1 shows an example of a fiducial implemented by removing material from optical component 208 at a first location to implement a first discontinuity in refraction plane 512 of optical component 208 at the first location. In other words, fiducial 110-1 may represent a small cavity in the cover glass material that may be laser etched into the surface or otherwise carved out. In some cases, the fiducial may include a matte surface (e.g., to produce a Lambertian emission for light 116-1), a grating (e.g., for direction and amplitude control of light 116-1), or the like. Fiducial 110-1 may be approximately 200-400 microns in diameter in one example, or may be another suitable size as may serve a particular implementation. Because the fiducial is so close to the camera, the fiducial likely will not be in focus in captured images but will appear with a relatively shapeless form (e.g., like a blurry smear). Accordingly, the shape of the fiducial may be of less importance than the size of the fiducial and any of a variety of shapes (e.g., circular, square, ‘+’-shaped, etc.) may be used.

Fiducial 110-2 shows an example of a fiducial implemented by adding material to optical component 208 at a second location (e.g., a different location from the first location) to implement a second discontinuity in refraction plane 512 of optical component 208 at the second location. For example, fiducial 110-2 may represent a small patch of film or other material (e.g., a small sticker) that may be imprinted or otherwise applied (e.g., adhesively attached) to the surface so as to change the refraction interface in an analogous way as a piece of dust might do. Similar size and shape considerations may be made for fiducial 110-2 as described above for fiducial 110-1. For example, the imprinted patch may be approximately 200-400 microns in diameter and may have a circular, square, or other suitable shape.

FIG. 6 shows illustrative ways that light may be introduced (e.g., allowed and/or injected) into an optical component for use in illuminating light-based fiducials for camera calibration in accordance with principles described herein. More particularly, FIG. 6 shows a portion of an implementation of optical component 208 (e.g., a cover glass or other optical component described herein) that includes a plurality of fiducials 110 (e.g., light-based fiducials such as fiducials 110-1 and 110-2 and other fiducials 110 described above).

As has been described, light-based fiducials such as fiducials 110 may operate by emitting light 116 that is allowed to exit from reflecting back and forth within the optical component due to a discontinuity of the refractive plane associated with the surface. In other words, proper operation of light-based fiducials may require illumination by light 114 reflecting back and forth (e.g., substantially trapped) within the optical component 208.

Accordingly, FIG. 6 shows two ways that light 114 may be introduced so as to be captured in total internal reflection between the surfaces rather than passing straight through.

First, light source 204 may be configured to inject light 114-1 into optical component 208 at a predetermined angle (e.g., 45°) that facilitates a fiducial illumination function in which the injected light reflects between surfaces of the optical component before exiting at one of the fiducials of the set of fiducials. This approach may be referred to herein as active illumination. Active illumination represented by light 114-1 could be produced by light source 204 (e.g., a laser light source or other suitable source, as described above) and injected into optical component 208 at a desirable angle (e.g., 45°) by injection optics 206.

For instance, if optical component 208 is formed from acrylic (n=1.49, for a critical angle of 42°), then total internal reflection may be substantially achieved by light propagating between the surfaces at a 45° angle as shown. To this end, injection optics 206 may be cut at an angle of 22.5° to direct collimated light traveling parallel with the planar surface of optical component 208 to be injected into optical component 208 at the 45° angle shown (or at another suitable angle for another material).

Second, optical component 208 may be configured to allow ambient light 602 (illustrated by arrows pointing in many directions) into optical component 208 at a predetermined angle (e.g., 45°) that facilitates the fiducial illumination function in which the ambient light reflects between surfaces of optical component 208 before exiting at one of the fiducials. This approach may be referred to herein as passive illumination. FIG. 6 shows that passive illumination represented by light 114-2 could be allowed in from scattered ambient light 602 that is not collimated and may be propagating in many directions (including at the desired 45° angle that will allow the light to propagate back and forth between the surfaces of optical component 208).

While passive illumination may be less effective in illuminating the set of fiducials 110, passive illumination may be sufficient for certain implementations and/or under certain circumstances and may be cheaper and/or more straightforward to implement in terms of design, power usage, and so forth. On the other hand, active illumination may provide various advantages such as the ability for the system to readily illuminate or turn off the illumination of the light-based fiducials as may be desirable or appropriate at a given moment in time. More image frames may be required to reliably detect passively illuminated fiducials than actively illuminated fiducials, which may be a worthwhile tradeoff in certain implementations and/or circumstances and may not be a worthwhile tradeoff in other cases.

As has been described, one benefit of light-based fiducials described herein is that the fiducials may be located within the field of view of the camera, and even within the field of view presented to the user, while still remaining virtually invisible (at least with regard to any given individual frame) so as to serve their calibration function without creating a distraction. To illustrate, FIG. 7 shows ways that light-based fiducials may be arranged with respect to the different fields of view in accordance with principles described herein. More particularly, different sets of fiducials are shown to be arranged with respect to a camera field of view 702 (analogous to fields of view 112 and/or 502 described above) and with respect to a user field of view 704 that is similar to, but slightly smaller than and contained within, camera field of view 702.

As shown in FIG. 7, a first set of fiducials 110-A and a second set of fiducials 110-B are both shown to be integrated with the optical component in a region associated with camera field of view 702. This field of view may represent the field of view that the image sensor of the camera can detect, though all the content captured in this field of view may not necessarily be presented to the user. For example, the first set of fiducials 110-A is shown to be visible to the image sensor (since it is included within camera field of view 702) while not being visible in content presented to the user (since it is not included within user field of view 704). For fiducials such as fiducials 110-A, there may be less concern about how large or conspicuous the fiducials are, since they would not present an unsightly blemish that could be distracting or annoying to the user. On the other hand, the arrangement of the first set of fiducials 110-A is shown to be constrained to the outer edges of the camera field of view 702 (where it does not overlap with the user field of view 704), thereby possibly making the fiducials (and resulting calibration operations relying on them) less effective. Moreover, this placement of fiducials 110-A requires that the user field of view 704 be at least somewhat smaller than the camera field of view 702, which means that some captured content that could be presented to the user is instead being discarded. This may be considered undesirable and inefficient in certain implementations.

In contrast with the set of fiducials 110-A, the set of fiducials 110-B is shown to be integrated with the optical component both in the region associated with the field of view of the image sensor (i.e., camera field of view 702) and further in a sub-region associated with a field of view presented to a user (i.e., user field of view 704). This fiducial placement cures each of the potential deficiencies mentioned above with respect to fiducials 110-A. For example, there are no restrictions on where fiducials 110-B may be positioned within camera field of view 702 (e.g., near the edges, near the center, etc.) and there is no reason that user field of view 704 needs to be any smaller than camera field of view 702 (there is no need to discard any captured image content just to hide the fiducials).

The only potential disadvantage of fiducial placement within user field of view 704 (as shown for the set of fiducials 110-B) is that, if the fiducials are visible to the user, they could be irritating or distracting or could even compromise the user's view in certain ways (blocking content the user is trying to see, etc.). For this reason, light-based fiducials described herein are highly advantageous when it comes to placement since these fiducials will be virtually invisible to the user (e.g., no more visible or distracting than a piece of dust that has landed on the cover glass) and may thus be placed anywhere within the sub-region associated with user field of view 704.

FIG. 8 shows how virtually-invisible, light-based fiducials positioned in the user field of view may nevertheless be detected by the imaging system for use in calibration operations described herein. More particularly, FIG. 8 shows illustrative aspects for how a plurality of images may be processed to detect an arrangement of light-based fiducials that may be virtually undetectable from any individual image in accordance with principles described herein.

As shown, a plurality of images 802 (each implemented by an instance of the image 214 described above) may be received by the imaging system and may undergo a filter processing 804 to filter out dynamic image content while producing a filtered image 806. In other words, a process such as one or more of processes 218 or method 300 described above may further include operations such as: 1) receiving the plurality of images 802 of the subject from the image sensor (where the plurality of images includes the original image 214 mentioned in processes such as method 300); and 2) based on the plurality of images 802, generating filtered image 806 in which dynamic image content is filtered out. The detecting the arrangement of the set of fiducials (e.g., such as described in relation to operation 304 of method 300) may then be performed using filtered image 806 (as opposed to using only the individual image 214 by itself).

The plurality of images 802 may include any suitable number of images of the subject as may serve a particular implementation. For instance, if there is strong active illumination of the light-based fiducials (e.g., including a reflective perimeter edge 508, etc.), a filtered image 806 based on a relatively small number of images 214 (e.g., 5-10 images, etc.) may be sufficient to reveal the arrangement of fiducials in a way that is readily detectable within an analysis of filtered image 806. Conversely, if there is more subtle active illumination or passive illumination of the light-based fiducials, a filtered image 806 based on a much larger number of images 214 (e.g., dozens, hundreds, or thousands of images, etc.) may be used to expose the arrangement of fiducials in a way that can be reliably detected by the imaging system.

Whatever number of image frames may be included in the plurality of images 802, filter processing 804 may be used to average out all the high-frequency information (i.e., dynamic image content) so that what remains is the static fiducials that persist in their locations within every image (since they are statically located on the optical component in the camera field of view). Filter processing 804 may be implemented using any digital filtering operations or algorithms as may serve a particular implementation. After the plurality of images 802 is averaged and filtered in this way, only low-frequency information or static content (e.g., the light-based fiducials and possibly other dust and/or smudges that happen to be present on the optical component) may be visible within filtered image 806, making the detection of the arrangement of fiducials much more straightforward when using filtered image 806 rather than using any individual image 214. This difference is shown in FIG. 8 by indicating that each image 214 depicts both the “Subject” and “Invisible Fiducials,” while the filtered image 806 does not depict the subject as such (since the subject would be represented in dynamic image content that has been averaged and filtered out), but does depict “Visible Fiducials.”

FIGS. 9A and 9B show different illustrative timelines for calibration sessions employing light-based fiducials that rely on injected light in accordance with principles described herein. More particularly, FIG. 9A shows a timeline 900-A and FIG. 9B shows a timeline 900-B that each represent various events such as the imaging system being powered up or turned on (“Power On System”), a calibration sequence 902 beginning (“Start Calibration Sequence”), the calibration sequence 902 ending (“Finish Calibration Sequence”), and the imaging system being powered down or turned off (“Power Off System”). It will be understood that events on the timelines are not drawn to scale. To illustrate, omission symbols 901 on the timelines are included to indicate that some amount of time may be omitted from (not explicitly shown on) the timeline before and after the calibration sequence 902.

Calibration sequence 902 may include any calibration operations described herein involving detected arrangements of light-based fiducials, as well as other camera calibration operations (e.g., determining intrinsic and/or extrinsic parameters of the cameras with respect to other optics, other cameras in the system, etc.) as may serve a particular implementation. In some examples, calibration operations of calibration sequence 902 may be performed as part of a factory calibration sequence in which a baseline calibration model is generated. For example, in the factory, there may be more flexibility and observability to perform a highly robust camera calibration with respect to the optical component such that a robust baseline model may be generated that can later be updated as changes occur. In other examples, calibration operations of calibration sequence 902 may be performed as part of an online (or in-field) calibration sequence in which a baseline calibration model that was previously generated (e.g., as part of the factory calibration sequence) may be updated to reflect changes to the optical component exhibited by the arrangement. In the field, there may be less flexibility and observability to perform camera calibration with respect to the optical component, but slight changes to fiducial arrangement that can be detected may allow for minor updates to be made to the previously generated calibration model to account for deviations beyond the baseline.

Online calibration updates may be performed with any suitable frequency (e.g., relatively continuously, very sporadically, etc.) and/or may be triggered based on particular conditions such as described below. For one specific example, the events of timelines 900-A and 900-B will be arbitrarily assumed to be associated with a two-hour extended reality session that a user may engage in using a head-mounted display device implementing the imaging system. In this example, the user may turn on the head-mounted display device and engage in the extended reality session for two hours before turning off the device. At the one-hour mark during the session, the head-mounted display device may perform calibration sequence 902 to update the calibration model for the cover glass. For instance, calibration sequence 902 may last for a few seconds or minutes or another suitable amount of time and may be performed, in some cases, in the background as the extended reality session continues to be presented to the user uninterrupted. Any suitable factor, weighing of factors, event, or sequence of events may trigger the calibration sequence 902 to be performed. For example, calibration sequence 902 may be triggered by a timer indicating that a periodic update is due, by a detection that the head-mounted display device has been dropped or experienced another event that is likely to have changed the pose of the cover glass, by a detection that the temperature of the device or the camera has reached a threshold that is likely to cause substantial changes to the cover glass influence, or for any other suitable reason. In other examples, a calibration sequence could be automatically performed at the beginning of each operation session (soon after powering on the system, etc.) or at another regular time.

In both examples of FIGS. 9A and 9B, the imaging system will be understood to include a light source configured to inject light into the optical component at an angle that facilitates a fiducial illumination function in which the injected light reflects between surfaces of the optical component before exiting at a fiducial of the set of fiducials. In other words, as described above, both calibration sequences 902 in FIGS. 9A and 9B may involve active illumination of the light-based fiducials in these examples. The difference between the example illustrated by timeline 900-A in FIG. 9A and the example illustrated by timeline 900-B in FIG. 9B, however, is shown to involve the placement on the timelines of an event 904 and an event 906. Event 904 may occur when a light source (e.g., light source 204) is enabled to actively illuminate light-based fiducials (e.g., fiducials 110) for calibration operations of calibration sequence 902. Event 906 may then occur when the light source is then disabled to cease the active illumination of the light-based fiducials.

In the example of timeline 900-A, FIG. 9A shows that event 904 occurs to enable the light source to inject the light into the optical component immediately before performing calibration sequence 902, while event 906 occurs to disable the light source from injecting the light into the optical component immediately after completing calibration sequence 902. Accordingly, in this example, the fiducials may be more readily detectable during calibration sequence 902 while being more subtle and less likely to be noticed or to distract from the experience during the remainder of the session. This limitation on the time that the active illumination is implemented may allow brighter illumination and/or larger fiducials to be used, since the fiducials may only be illuminated for a few frames (e.g., less than a second in certain examples) and are therefore less prone to causing a problem or distraction.

In the example of timeline 900-B, in contrast, FIG. 9B shows that event 904 occurs to enable the light source to inject the light into the optical component immediately as the session begins and event 906 occurs to disable the light source from injecting the light into the optical component only at the end of the session. In other words, the imaging system in this example may enable the light source to inject the light into the optical component whenever the system is operational, such that the light source performs both the fiducial illumination function and an operational indication function in which the light doubles as a power light (e.g., indicating that the device is powered on) and/or an indicator that a session is underway. Since the fiducials are always on in this example, the fiducials may be configured to be more subtle and less prone to being noticed or to distract from the experience, thereby possibly requiring more image frames in the plurality of images 802 to detect the arrangement.

As has been mentioned, various methods and processes described herein may be implemented at least in part as instructions embodied in a non-transitory computer-readable medium and executable by one or more computing devices. In general, a processor (e.g., a microprocessor) receives instructions, from a non-transitory computer-readable medium (e.g., a memory, etc.), and executes those instructions, thereby performing one or more operations such as the operations described herein. Such instructions may be stored and/or transmitted using any of a variety of known computer-readable media.

A computer-readable medium (also referred to as a processor-readable medium) includes any non-transitory medium that participates in providing data (e.g., instructions) that may be read by a computer (e.g., by a processor of a computer). Such a medium may take many forms, including, but not limited to, non-volatile media, and/or volatile media. Non-volatile media may include, for example, optical or magnetic disks and other persistent memory. Volatile media may include, for example, dynamic random-access memory (DRAM), which typically constitutes a main memory. Common forms of computer-readable media include, for example, a disk, hard disk, magnetic tape, any other magnetic medium, a compact disc read-only memory (CD-ROM), a digital video disc (DVD), any other optical medium, random access memory (RAM), programmable read-only memory (PROM), electrically erasable programmable read-only memory (EPROM), FLASH-EEPROM, any other memory chip or cartridge, or any other tangible medium from which a computer can read.

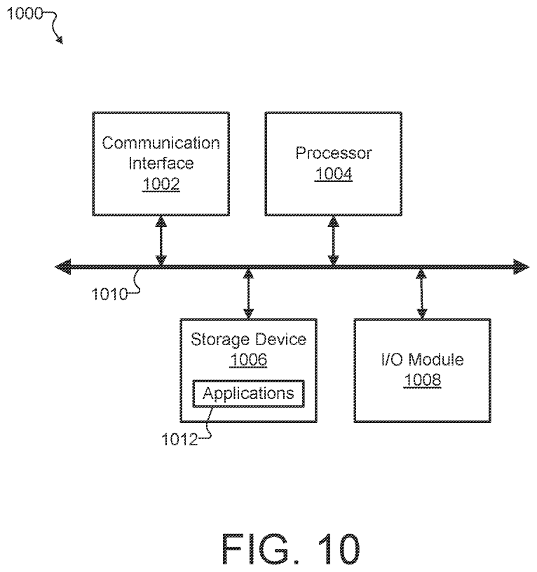

FIG. 10 shows an illustrative computing system 1000 that may be used to implement various devices and/or systems described herein. For example, computing system 1000 may include or implement (or partially implement) imaging systems such as imaging system 200, any implementations thereof, any components thereof, and/or other devices used therewith.

As shown in FIG. 10, computing system 1000 may include a communication interface 1002, a processor 1004, a storage device 1006, and an input/output (I/O) module 1008 communicatively connected via a communication infrastructure 1010. While an illustrative computing system 1000 is shown in FIG. 10, the components illustrated in FIG. 10 are not intended to be limiting. Additional or alternative components may be used in other embodiments. Components of computing system 1000 shown in FIG. 10 will now be described in additional detail.

Communication interface 1002 may be configured to communicate with one or more computing devices. Examples of communication interface 1002 include, without limitation, a wired network interface (such as a network interface card), a wireless network interface (such as a wireless network interface card), a modem, an audio/video connection, and any other suitable interface.

Processor 1004 generally represents any type or form of processing unit capable of processing data or interpreting, executing, and/or directing execution of one or more of the instructions, processes, and/or operations described herein. Processor 1004 may direct execution of operations in accordance with one or more applications 1012 or other computer-executable instructions such as may be stored in storage device 1006 or another computer-readable medium.

Storage device 1006 may include one or more data storage media, devices, or configurations and may employ any type, form, and combination of data storage media and/or device. For example, storage device 1006 may include, but is not limited to, a hard drive, network drive, flash drive, magnetic disc, optical disc, RAM, dynamic RAM, other non-volatile and/or volatile data storage units, or a combination or sub-combination thereof. Electronic data, including data described herein, may be temporarily and/or permanently stored in storage device 1006. For example, data representative of one or more executable applications 1012 configured to direct processor 1004 to perform any of the operations described herein may be stored within storage device 1006. In some examples, data may be arranged in one or more databases residing within storage device 1006.

I/O module 1008 may include one or more I/O modules configured to receive user input and provide user output. One or more I/O modules may be used to receive input for a single virtual experience. I/O module 1008 may include any hardware, firmware, software, or combination thereof supportive of input and output capabilities. For example, I/O module 1008 may include hardware and/or software for capturing user input, including, but not limited to, a keyboard or keypad, a touchscreen component (e.g., touchscreen display), a receiver (e.g., an RF or infrared receiver), motion sensors, and/or one or more input buttons.

I/O module 1008 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O module 1008 is configured to provide graphical data to a display for presentation to a user. The graphical data may be representative of one or more graphical user interfaces and/or any other graphical content as may serve a particular implementation.

The following examples describe implementations of light-based fiducials for camera calibration with respect to an optical component in accordance with principles described herein.

Example 1: A system comprising: an image sensor configured for imaging a subject; an optical component positioned between the image sensor and the subject; a set of fiducials integrated with the optical component in a region associated with a field of view of the image sensor, the set of fiducials implementing respective discontinuities in a refraction plane of the optical component; and a processor configured to perform a process comprising: receiving an image of the subject from the image sensor; detecting, using the image and based on anomalous light propagation through the respective discontinuities, an arrangement of the set of fiducials; and based on the arrangement, performing a calibration operation to account for an effect of the optical component on light detected by the image sensor.

Example 2: The system of any of the preceding examples, wherein: the process further comprises: receiving a plurality of images of the subject from the image sensor, the plurality of images including the image, and based on the plurality of images, generating a filtered image in which dynamic image content is filtered out; and the detecting the arrangement of the set of fiducials is performed using the filtered image.

Example 3: The system of any of the preceding examples, further comprising a light source configured to inject light into the optical component at an angle that facilitates a fiducial illumination function in which the injected light reflects between surfaces of the optical component before exiting at a fiducial of the set of fiducials.

Example 4: The system of any of the preceding examples, wherein the process further comprises enabling the light source to inject the light into the optical component whenever the system is operational, the light source thereby performing both the fiducial illumination function and an operational indication function.

Example 5: The system of any of the preceding examples, wherein the process further comprises: enabling, immediately before performing a calibration sequence that includes the calibration operation, the light source to inject the light into the optical component; and disabling, immediately after completing the calibration sequence, the light source from injecting the light into the optical component.

Example 6: The system of any of the preceding examples, wherein the optical component is configured to allow ambient light into the optical component at an angle that facilitates a fiducial illumination function in which the ambient light reflects between surfaces of the optical component before exiting at a fiducial of the set of fiducials.

Example 7: The system of any of the preceding examples, wherein: the optical component is implemented as a planar component having a first planar surface, a second planar surface opposite the first planar surface; and a perimeter edge connecting the first planar surface and the second planar surface; and at least a portion of the perimeter edge is configured to reflect light propagating between the first planar surface and the second planar surface to deter the light from exiting the optical component at the perimeter edge.

Example 8: The system of any of the preceding examples, implemented as an extended reality presentation system that includes a head-mounted display device in which the image sensor and the optical component are integrated; wherein the optical component is implemented by a cover glass for the head-mounted display device and the image sensor is implemented by a world-facing camera behind the cover glass in the head-mounted display device.

Example 9: The system of any of the preceding examples, wherein the set of fiducials is integrated with the optical component both in the region associated with the field of view of the image sensor and further in a sub-region associated with a field of view presented to a user.

Example 10: The system of any of the preceding examples, implemented as an extended reality presentation system that includes a head-mounted display device in which the image sensor and the optical component are integrated; wherein the optical component is associated with an internal display for the head-mounted display device and the image sensor is associated with an eye-tracking camera integrated within the head-mounted display device to track eye movements of a user viewing the internal display.

Example 11: The system of any of the preceding examples, wherein the calibration operation is performed as part of a factory calibration sequence in which a baseline calibration model is generated.

Example 12: The system of any of the preceding examples, wherein the calibration operation is performed as part of an online calibration sequence in which a baseline calibration model that was previously generated is updated to reflect changes to the optical component exhibited by the arrangement.

Example 13: The system of any of the preceding examples, wherein the set of fiducials includes a first fiducial implemented by removing material from the optical component at a first location to implement a first discontinuity in the refraction plane of the optical component at the first location.

Example 14: The system of any of the preceding examples, wherein the set of fiducials includes a second fiducial implemented by adding material to the optical component at a second location to implement a second discontinuity in the refraction plane of the optical component at the second location.

Example 15: A method comprising: receiving, from an image sensor configured to image a subject through an optical component positioned between the image sensor and the subject, an image of the subject; detecting, using the image and based on anomalous light propagation through respective discontinuities in a refraction plane of the optical component, an arrangement of a set of fiducials, the set of fiducials being integrated with the optical component in a region associated with a field of view of the image sensor and implementing the respective discontinuities; and based on the arrangement, performing a calibration operation to account for an effect of the optical component on light detected by the image sensor.

Example 16: The method of any of the preceding examples, further comprising: receiving a plurality of images of the subject from the image sensor, the plurality of images including the image; and based on the plurality of images, generating a filtered image in which dynamic image content is filtered out; wherein the detecting the arrangement of the set of fiducials is performed using the filtered image.

Example 17: The method of any of the preceding examples, further comprising: enabling a light source to inject light into the optical component at an angle that facilitates a fiducial illumination function in which the injected light reflects between surfaces of the optical component before exiting at a fiducial of the set of fiducials; wherein the enabling is performed whenever a system including the image sensor and the optical component is operational, the light source thereby performing both the fiducial illumination function and an operational indication function.

Example 18: The method of any of the preceding examples, further comprising: enabling, immediately before performing a calibration sequence that includes the calibration operation, a light source to inject light into the optical component at an angle that facilitates a fiducial illumination function in which the injected light reflects between surfaces of the optical component before exiting at a fiducial of the set of fiducials; and disabling, immediately after completing the calibration sequence, the light source from injecting the light into the optical component.

Example 19: A non-transitory computer-readable medium storing instructions that, when executed, cause a processor of an imaging system to perform a process comprising: receiving, from an image sensor configured to image a subject through an optical component positioned between the image sensor and the subject, an image of the subject; detecting, using the image and based on anomalous light propagation through respective discontinuities in a refraction plane of the optical component, an arrangement of a set of fiducials, the set of fiducials being integrated with the optical component in a region associated with a field of view of the image sensor and implementing the respective discontinuities; and based on the arrangement, performing a calibration operation to account for an effect of the optical component on light detected by the image sensor.

Example 20: The non-transitory computer-readable medium of any of the preceding examples, wherein: the process further comprises: receiving a plurality of images of the subject from the image sensor, the plurality of images including the image, and based on the plurality of images, generating a filtered image in which dynamic image content is filtered out; and the detecting the arrangement of the set of fiducials is performed using the filtered image.

Various implementations of the systems and techniques described herein can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

A number of implementations have been described. Nevertheless, it will be understood that various modifications may be made without departing from the spirit and scope of the description and claims. In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

Specific structural and functional details disclosed herein are merely representative for purposes of describing example implementations. Example implementations, however, may be embodied in many alternate forms and should not be construed as limited to only the implementations set forth herein.

It will be understood that, although the terms first, second, etc. may be used herein to describe various elements, these elements should not be limited by these terms. These terms are only used to distinguish one element from another. A first element could be termed a second element, and, similarly, a second element could be termed a first element, without departing from the scope of the implementations of the disclosure. As used herein, the term and/or includes any and all combinations of one or more of the associated listed items.

The terminology used herein is for the purpose of describing particular implementations only and is not intended to be limiting of the implementations. As used herein, the singular forms “a,” “an,” and “the” are intended to include the plural forms as well, unless the context clearly indicates otherwise. It will be further understood that the terms “comprises,” “comprising,” “includes,” and/or “including,” when used in this specification, specify the presence of the stated features, steps, operations, elements, and/or components, but do not preclude the presence or addition of one or more other features, steps, operations, elements, components, and/or groups thereof.

It will be understood that when an element is referred to as being “coupled,” “connected,” or “responsive” to, or “on,” another element, it can be directly coupled, connected, or responsive to, or on, the other element, or intervening elements may also be present. In contrast, when an element is referred to as being “directly coupled,” “directly connected,” or “directly responsive” to, or “directly on,” another element, there are no intervening elements present. As used herein the term “and/or” includes any and all combinations of one or more of the associated listed items.

Spatially relative terms, such as “beneath,” “below,” “lower,” “above,” “upper,” and the like, may be used herein for ease of description to describe one element or feature in relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” can encompass both an orientation of above and below. The device may be otherwise oriented (rotated 130 degrees or at other orientations) and the spatially relative descriptors used herein may be interpreted accordingly.

Unless otherwise defined, the terms (including technical and scientific terms) used herein have the same meaning as commonly understood by one of ordinary skill in the art to which these concepts belong. It will be further understood that terms, such as those defined in commonly used dictionaries, should be interpreted as having a meaning that is consistent with their meaning in the context of the relevant art and/or the present specification and will not be interpreted in an idealized or overly formal sense unless expressly so defined herein.

Further to the descriptions above, a user may be provided with controls allowing the user to make an election as to both if and when systems, programs, or features described herein may enable collection of user information (e.g., information about a user's social network, social actions, or activities, profession, a user's preferences, or a user's current location), and if the user is sent content or communications from a server. In addition, certain data may be treated in one or more ways before it is stored or used, so that personally identifiable information is removed. For example, a user's identity may be treated so that no personally identifiable information can be determined for the user, or a user's geographic location may be generalized, or location information may be obtained (such as to a city, zip code, or state level), so that a particular location of a user cannot be determined. Thus, the user may have control over what information is collected about the user, how that information is used, and what information is provided to the user.

While certain features of the described implementations have been illustrated as described herein, many modifications, substitutions, changes, and equivalents may occur to those skilled in the art. It is therefore to be understood that the appended claims are intended to cover such modifications and changes as fall within the scope of the implementations. It will be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components, and/or features of the different implementations described. As such, the scope of the present disclosure is not limited to the particular combinations hereafter claimed, but instead extends to encompass any combination of features or example implementations described herein irrespective of whether or not that particular combination has been specifically enumerated in the accompanying claims at this time.

1. A system comprising:
an image sensor configured for imaging a subject;
an optical component positioned between the image sensor and the subject;
a set of fiducials integrated with the optical component in a region associated with a field of view of the image sensor, the set of fiducials implementing respective discontinuities in a refraction plane of the optical component; and
a processor configured to perform a process comprising:
receiving an image of the subject from the image sensor;
detecting, using the image and based on anomalous light propagation through the respective discontinuities, an arrangement of the set of fiducials; and
based on the arrangement, performing a calibration operation to account for an effect of the optical component on light detected by the image sensor.

2. The system of claim 1, wherein:
the process further comprises:
receiving a plurality of images of the subject from the image sensor, the plurality of images including the image, and
based on the plurality of images, generating a filtered image in which dynamic image content is filtered out; and
the detecting the arrangement of the set of fiducials is performed using the filtered image.

3. The system of claim 1, further comprising a light source configured to inject light into the optical component at an angle that facilitates a fiducial illumination function in which the injected light reflects between surfaces of the optical component before exiting at a fiducial of the set of fiducials.

4. The system of claim 3, wherein the process further comprises enabling the light source to inject the light into the optical component whenever the system is operational, the light source thereby performing both the fiducial illumination function and an operational indication function.

5. The system of claim 3, wherein the process further comprises:
enabling, immediately before performing a calibration sequence that includes the calibration operation, the light source to inject the light into the optical component; and
disabling, immediately after completing the calibration sequence, the light source from injecting the light into the optical component.

6. The system of claim 1, wherein the optical component is configured to allow ambient light into the optical component at an angle that facilitates a fiducial illumination function in which the ambient light reflects between surfaces of the optical component before exiting at a fiducial of the set of fiducials.

7. The system of claim 1, wherein:
the optical component is implemented as a planar component having a first planar surface, a second planar surface opposite the first planar surface; and a perimeter edge connecting the first planar surface and the second planar surface; and
at least a portion of the perimeter edge is configured to reflect light propagating between the first planar surface and the second planar surface to deter the light from exiting the optical component at the perimeter edge.

8. The system of claim 1, implemented as an extended reality presentation system that includes a head-mounted display device in which the image sensor and the optical component are integrated;
wherein the optical component is implemented by a cover glass for the head-mounted display device and the image sensor is implemented by a world-facing camera behind the cover glass in the head-mounted display device.

9. The system of claim 8, wherein the set of fiducials is integrated with the optical component both in the region associated with the field of view of the image sensor and further in a sub-region associated with a field of view presented to a user.

10. The system of claim 1, implemented as an extended reality presentation system that includes a head-mounted display device in which the image sensor and the optical component are integrated;
wherein the optical component is associated with an internal display for the head-mounted display device and the image sensor is associated with an eye-tracking camera integrated within the head-mounted display device to track eye movements of a user viewing the internal display.

11. The system of claim 1, wherein the calibration operation is performed as part of a factory calibration sequence in which a baseline calibration model is generated.

12. The system of claim 1, wherein the calibration operation is performed as part of an online calibration sequence in which a baseline calibration model that was previously generated is updated to reflect changes to the optical component exhibited by the arrangement.

13. The system of claim 1, wherein the set of fiducials includes a first fiducial implemented by removing material from the optical component at a first location to implement a first discontinuity in the refraction plane of the optical component at the first location.

14. The system of claim 1, wherein the set of fiducials includes a second fiducial implemented by adding material to the optical component at a second location to implement a second discontinuity in the refraction plane of the optical component at the second location.

15. A method comprising:
receiving, from an image sensor configured to image a subject through an optical component positioned between the image sensor and the subject, an image of the subject;
detecting, using the image and based on anomalous light propagation through respective discontinuities in a refraction plane of the optical component, an arrangement of a set of fiducials, the set of fiducials being integrated with the optical component in a region associated with a field of view of the image sensor and implementing the respective discontinuities; and
based on the arrangement, performing a calibration operation to account for an effect of the optical component on light detected by the image sensor.

16. The method of claim 15, further comprising:
receiving a plurality of images of the subject from the image sensor, the plurality of images including the image; and
based on the plurality of images, generating a filtered image in which dynamic image content is filtered out;
wherein the detecting the arrangement of the set of fiducials is performed using the filtered image.

17. The method of claim 16, further comprising:
enabling a light source to inject light into the optical component at an angle that facilitates a fiducial illumination function in which the injected light reflects between surfaces of the optical component before exiting at a fiducial of the set of fiducials;
wherein the enabling is performed whenever a system including the image sensor and the optical component is operational, the light source thereby performing both the fiducial illumination function and an operational indication function.

18. The method of claim 15, further comprising:
enabling, immediately before performing a calibration sequence that includes the calibration operation, a light source to inject light into the optical component at an angle that facilitates a fiducial illumination function in which the injected light reflects between surfaces of the optical component before exiting at a fiducial of the set of fiducials; and
disabling, immediately after completing the calibration sequence, the light source from injecting the light into the optical component.

19. A non-transitory computer-readable medium storing instructions that, when executed, cause a processor of an imaging system to perform a process comprising:
receiving, from an image sensor configured to image a subject through an optical component positioned between the image sensor and the subject, an image of the subject;
detecting, using the image and based on anomalous light propagation through respective discontinuities in a refraction plane of the optical component, an arrangement of a set of fiducials, the set of fiducials being integrated with the optical component in a region associated with a field of view of the image sensor and implementing the respective discontinuities; and
based on the arrangement, performing a calibration operation to account for an effect of the optical component on light detected by the image sensor.

20. The non-transitory computer-readable medium of claim 19, wherein:
the process further comprises:
receiving a plurality of images of the subject from the image sensor, the plurality of images including the image, and
based on the plurality of images, generating a filtered image in which dynamic image content is filtered out; and
the detecting the arrangement of the set of fiducials is performed using the filtered image.
